(19) United States
(12) Patent Application Publication
(10) Pub. No.: US 2002/0093163 A1
(43) Pub. Date: Jul. 18, 2002

(54) Skate cart brake

(76) Inventor: Dean Tai, W. Covina, CA (US)

Correspondence Address: Street Boogie, ATTN: Dean Tai, 2750 Artesia Blvd, Redondo Beach, CA, 90278, US

(21) Appl. No.: 09/760,767

(22) Filed: Jan. 16, 2001

(51) Int. Cl. B62M 1/00; B62L 1/00

(52) U.S. Cl. 280/87.041; 188/19

(57) ABSTRACT

A brake device for a skate cart or scooter includes a rigid wheel hood frame mounted around a rear wheel. A footrest is positioned behind the wheel hood to allow a user to rest a heel on the rear footrest. The rigid wheel hood frame is formed with an opening to allow a brake stop to contact with the wheel when a toe is pressed down on the brake stop. The brake stop is connected with a resilient member so that brake stop is pivoted to contact the rear wheel by stepping on the brake stop. The brake stop returns by the resilient member when the user removes a foot from the brake stop.

### BACKGROUND OF THE INVENTION

1. Field of the Invention

The present invention relates to a brake device for skate carts.

2. Description of Related Art

A conventional skate cart generally includes a frame with a front wheel and a rear wheel. A steerer tube is connected to the front wheel and a handlebar assembly is connected to the steerer tube so that when rotating the handlebar assembly, the skate cart turns accordingly. A conventional brake device is employed to stop the rear wheel and the brake device is similar to that of a bicycle. In other words, the conventional brake device uses a brake cable connected between the rear wheel rim and a brake lever on the handlebar assembly, and the other brake cable is connected between the other brake lever and the front wheel rim. When pulling the levers, the brake device is actuated by the brake cables to stop the front wheel and the rear wheel. However, the brake cables could be tangled by the handlebar assembly and it requires a lot of parts for the brake device.

Tsai 6,139,035 provides a brake device for a skate cart wherein the rear wheel has a pivotal rear wheel hood connected with a resilient member so that the rear wheel hood is pivoted to contact the rear wheel by stepping on the hood and the hood returns by the resilient member when the user removes his/her foot from the rear wheel hood. Unfortunately, the Tsai device is difficult to use at higher speeds, does not have a footrest for balance, and is difficult to use while stopped.

### SUMMARY OF THE INVENTION

The invention is an improved brake device for a skate cart wherein a rigid wheel hood frame is mounted around the rear wheel. A footrest is positioned behind the wheel hood to allow a user to rest a heel on the rear footrest. The rigid wheel hood frame is formed with an opening to allow a brake stop to contact with the wheel when a toe is pressed down on the brake stop.

The brake stop is connected with a resilient member so that brake stop is pivoted to contact the rear wheel by stepping on the brake stop. The brake stop returns by the resilient member when the user removes a foot from the brake stop.

The footrest and brake stop allow a user to operate the braking device much as one would operate an automobile brake. The brake stop can also be shaped to conform to the rear wheel and maximize contact area.

### BRIEF DESCRIPTION OF THE DRAWINGS

FIG. 1 is a perspective view of the device.

FIG. 2 is a side view of the device.

FIG. 3 is a top view of the device.

FIG. 4 is a top view of the foot rest.

FIG. 5 is a side view of the foot rest.

### DESCRIPTION OF THE PREFERRED EMBODIMENT

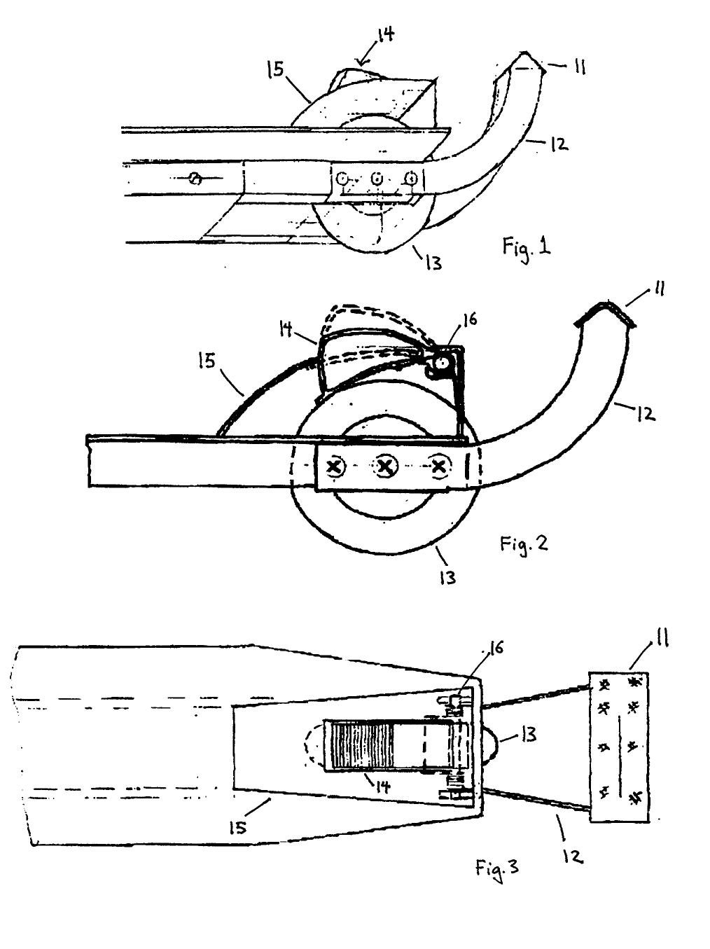

In FIG. 1, 2, and 3 the brake stop 14 is depressed to contact and slow or stop the wheel 13. The brake stop 14 is held by the rigid wheel hood frame 15 and oriented to contact the wheel 13 so that the brake stop 14 drags and the pin joint 16 is pulled in the direction that the wheel 13 spins. Assuming that the skate cart is moving forward to the left as in FIG. 1-5, the top of the wheel 13 moves to the left also. The force against the pin joint 16 is thus a pulling force to the left. The pulling force to the left allows greater durability and reliability of the brake device and of the wheel.

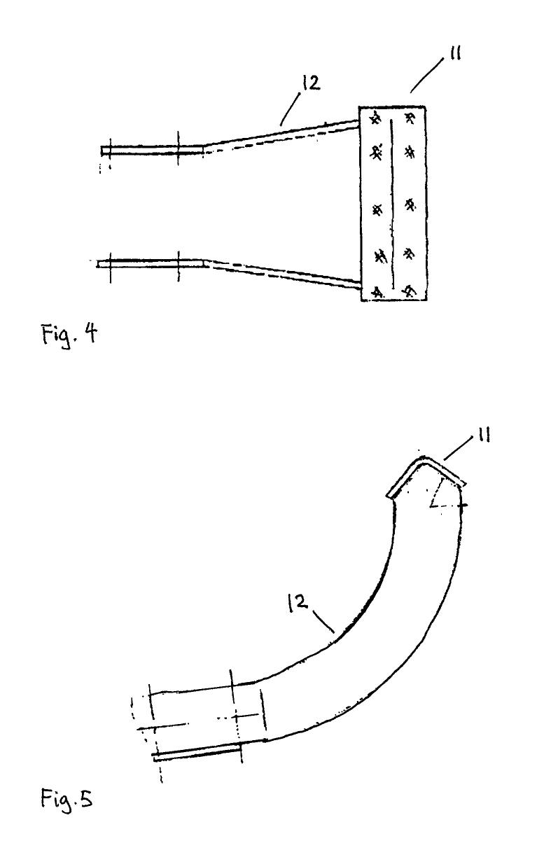

The user can balance a heel on the foot rest 11, while the user steps on the brake stop 14 with his or her toe. The foot rest 11 is held in place by two footrest supports attached to the frame of the skate cart. The brake stop FIG. 3, 14 has a grippy top surface to prevent foot slippage

1. A skate cart comprising: a frame, a front wheel and a rear wheel respectively connected to two ends of said frame, a handlebar assembly operationally connected to said front wheel, and
a rigid wheel hood frame mounted around the rear wheel,
a rear footrest positioned behind said rigid wheel hood frame allowing a user to rest a heel on the rear footrest,
a brake stop connected with a resilient member to said rigid wheel hood frame wherein said rigid wheel hood frame is formed with an opening to allow said brake stop to contact with the rear wheel when a toe steps on the brake stop, said brake stop able to return by the resilient member when the user stops stepping on the brake stop.

2. The device as in claim 1, wherein said brake stop is shaped to conform to the rear wheel, wherein said brake stop has a grippy top surface to prevent foot slippage.

3. A skate cart brake device comprising:
a rigid wheel hood frame mounted around a rear wheel,
a rear footrest positioned behind said rigid wheel hood frame allowing a user to rest a heel on the rear footrest,
a brake stop connected with a resilient member to said rigid wheel hood frame wherein said rigid wheel hood frame is formed with an opening to allow said brake stop to pivotally contact with the rear wheel when a toe steps on the brake stop, said brake stop able to return by the resilient member when the user stops stepping on the brake stop.

4. The device as in claim 3, wherein said rear footrest has a hole defined therein and said resilient member is connected to said rigid wheel hood frame by a bolt extending through said resilient member and threadedly engaged with said hole in said frame, whereby said brake stop has an unconnected end which is biased upward by said resilient member, wherein said brake stop has a grippy top surface to prevent foot slippage.

5. The device as in claim 4, wherein said brake stop is shaped to conform to the rear wheel.

6. The device as in claim 3, wherein said brake stop is shaped to conform to the rear wheel.

7. The device as in claim 3, wherein said rear footrest is positioned at the same height to allow a user to keep a rear foot parallel to the ground while skating.

8. The device as in claim 7, wherein said rear footrest is positioned at the same height to allow a user to keep a rear foot parallel to the ground while skating.

9. The device as in claim 8, wherein said rear footrest is configured to have a round top surface, whereby a user can more easily ride the skate cart on the rear wheel alone and keep a rear foot on the brake stop.

10. The device as in claim 9, wherein said rear footrest is configured to have an angled top surface, whereby a user can more easily ride the skate cart on the rear wheel alone and keep a rear foot on the brake stop.
